(19) United States
(12) Patent Application Publication
(10) Pub. No.: US 2008/0211760 A1
(43) Pub. Date: Sep. 4, 2008

(54) Liquid Crystal Display and Gate Driving Circuit Thereof

(76) Inventors: Seung-Soo Baek, Seoul (KR); Yong Soon Lee, Cheonan-si (KR); Min Cheol Lee, Seoul (KR); Young Bum Kim, Yongin-si (KR); Sang Jin Jeon, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/932,532

(22) Filed: Oct. 31, 2007

(30) Foreign Application Priority Data
Dec. 11, 2006 (KR) 10-2006-0125333
Dec. 19, 2006 (KR) 10-2006-0129732

(51) Int. Cl. G09G 3/36

(52) U.S. Cl. 345/98; 345/92; 345/87

(57) ABSTRACT

A liquid crystal display and a dual gate driving circuit therefor wherein the number of signal lines are reduced by sharing a start pulse and an output signal of a dummy stage. The liquid crystal display includes a timing controller generating an output enable signal, a gate clock, and a signal start signal in response to an external input signal, a level shifter generating a gate clock pulse and a gate clock bar pulse in response to the output enable signal and the gate clock and generating a single start pulse in response to the start signal and the gate clock, and first and second gate driving circuits outputting the gate clock pulse or the gate clock bar pulse as a gate driving signal to the plurality of gate lines in response to the single start pulse.

### CROSS-REFERENCE TO RELATED APPLICATIONS

This application claims priority of Korean Patent Applications Nos. 10-2006-0125333 and 10-2006-0129732, filed on Dec. 11, 2006 and Dec. 19, 2006, respectively, the entire contents of which are incorporated by reference herein.

### BACKGROUND OF THE INVENTION

1. Field of the Invention

The present invention relates to a liquid crystal display (LCD), and more particularly, to an LCD and gate driving circuit thereof.

2. Discussion of the Related Art

LCDs include an LCD panel for displaying an image, and data and gate driving circuits for driving the LCD panel. The LCD panel includes a plurality of gate lines, data lines, and pixels. Each pixel includes a thin film transistor (TFT) and a liquid crystal capacitor. The data driving circuit outputs data signals to the data lines and the gate driving circuit outputs gate driving signals to gate lines.

The gate driving circuit is formed on the LCD panel simultaneously with and by the same processes as those to form the TFTs. The data driving circuit has a chip type configuration that is connected to a peripheral area of the LCD panel. The gate driving circuit includes a shifter register which has a plurality of stages, each of which is connected to a corresponding gate line to output the gate driving signals.

The stages of the gate driving circuit are connected to each other to sequentially output the gate driving signals to the gate lines. An input terminal of a current stage is connected to an output terminal of a previous stage and an output terminal of a next stage is connected to a control terminal of the current stage. A start signal is input to a first one of the stages. The above-configured gate driving circuit is provided to each of the left and right sides of the LCD panel. A left gate driving circuit drives odd-numbered gate lines, while a right gate driving circuit drives even-numbered gate lines. Thus, the gate driving unit drives the gate lines by a single driving system.

In the single driving type LCD, gate driving signals output from the left and right gate driving circuits are delayed toward the ends of the gate lines causing some of the pixels to be insufficiently charged thereby resulting in a horizontal line visibility phenomenon. To solve the problem of the insufficient pixel charging time in the single driving system, a dual driving system has been proposed. The dual driving system includes a pair of driving circuits provided to left and right sides of an LCD panel to provide the same gate driving signals to the gate lines.

However, the foregoing approach requires twice as many signal lines as in the single driving type LCD and thus more space is required for integration of the LCD panel and increasing fabricating costs of the LCD panel.

### SUMMARY OF THE INVENTION

In accordance with the exemplary embodiments described herein, an LCD and a gate driving circuit are provided that require fewer signal lines to be connected to the gate driving circuit inter alia, by sharing the start pulse of a dual gate driving circuit and an output signal of a dummy stage.

In one exemplary embodiment, a gate clock pulse or a gate clock bar pulse is output as a gate driving signal to each of the gate lines in response to a single start pulse. The received start pulse is applied to an input terminal of each of a first odd-numbered stage and a first even-numbered one of the stages, wherein the output terminals of the stages are connected to the gate lines.

In another exemplary embodiment, a liquid crystal display includes a timing controller generating an output enable signal, a gate clock, and a signal start signal in response to an external input signal, a level shifter generating a gate clock pulse and a gate clock bar pulse in response to the output enable signal and the gate clock and generating a single start pulse in response to the start signal and the gate clock, and first and second gate driving circuits outputting the gate clock pulse or the gate clock bar pulse as a gate driving signal to a plurality of gate lines in response to the single start pulse.

A better understanding of the above and many other features and advantages of the present invention may be obtained from a consideration of the detailed description below.

### BRIEF DESCRIPTION OF THE DRAWINGS

FIG. 1 is a block diagram of an LCD according to one embodiment of the present invention;

FIG. 2 is a block diagram showing input and output signals of first and second level shifters shown in FIG. 1;

FIG. 3 is a circuit diagram of the first level shifter shown in FIG. 2;

FIG. 4 is a block diagram of an exemplary embodiment of first and second gate driving circuits shown in FIG. 2; FIG. 5 is a circuit diagram of a first stage shown in FIG. 4;

FIG. 6A and FIG. 6B are graphs for comparing operations of gate driving circuits by start pulses in a related art LCD and in an LCD according to one embodiment of the present invention;

FIG. 7 is a block diagram of another exemplary embodiment of the first and second gate driving circuits shown in FIG. 2;

FIG. 8A and FIG. 8B are graphs for comparing operations of gate driving circuits in a related art LCD and in an LCD according to another embodiment of the present invention; and

FIG. 9 is a graph showing an output waveform of an (n+2)^{th} stage of each of the first and second gate driving circuits shown in FIG. 7.

### DETAILED DESCRIPTION OF THE INVENTION

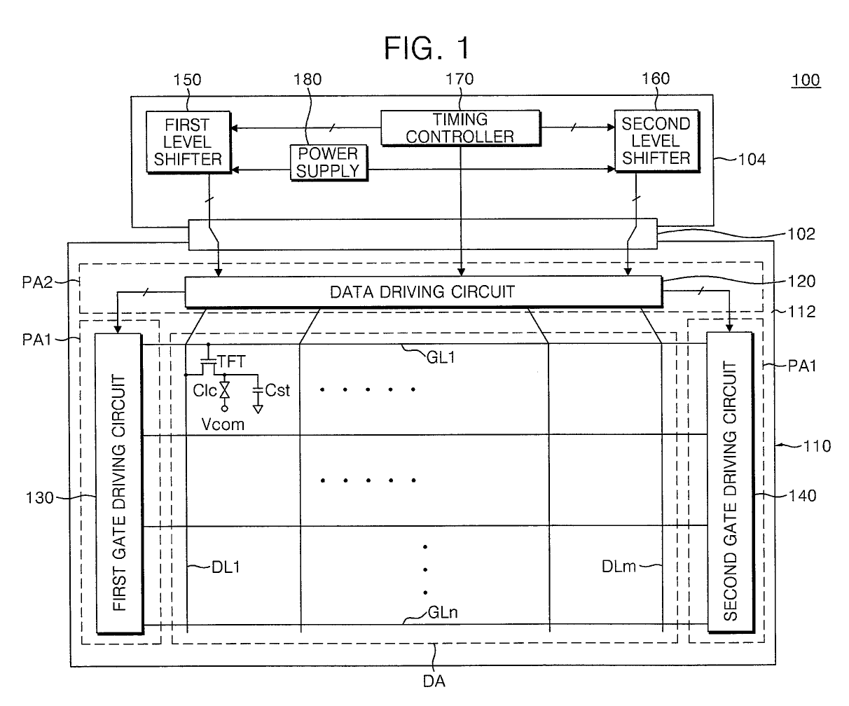

FIG. 1 is a block diagram of an LCD according to one embodiment of the present invention.

Referring to FIG. 1, an LCD 100 according to an exemplary embodiment of the present invention includes an LCD panel 110, a data driving circuit 120, a first gate driving circuit 130, a second gate driving circuit 140, a first level shifter 150, a second level shifter 160, a timing controller 170, and a power supply 180.

The LCD panel 110 includes a TFT substrate 112, a color filer substrate (not shown), and a liquid crystal layer (not shown) disposed between the TFT substrate 112 and the color filter substrate.

The TFT substrate 112 includes a display area DA, first peripheral areas PA1, and a second peripheral area PA2. The display area DA is provided with gate lines GL1 to GLn, data lines DL1 to DLm, and pixels connected to the gate lines GL1 to GLn and the data lines DL1 to DLm, respectively. The first peripheral areas PA1 is provided with the first and second gate driving circuits 130 and 140 for driving the gate lines GL1 to GLn. The data driving circuit 120 for driving the data lines DL1 to DLm is formed in the second peripheral area PA2. The first peripheral areas PA1 are adjacent to both ends of the gate lines GL1 to GLn and the second peripheral area PA2 is adjacent to one ends of the data lines DL1 to DLm.

Each pixel, e.g., one pixel includes a TFT connected to the gate line GL1 and the data line DL1, an LCD capacitor CIC connected to the TFT, and a storage capacitor Cst connected to the TFT. The gate and the source of the TFT are respectively connected to the gate line GL1 and the data line DL1, and the drain of the TFT is connected to the LCD capacitor CIc and the storage capacitor Cst. The LCD capacitor CIc includes a pixel electrode, a common electrode, and a liquid crystal layer functioning as a dielectric between the two electrodes.

The color filter substrate includes a black matrix that prevents leakage of light, a color filter for displaying colors, and the common electrode. Liquid crystal of the liquid crystal layer, which has dielectric anisotropy is twisted by a difference between voltages applied to the common electrode and the pixel electrode, thereby adjusting the transmittance of light.

The first and second gate driving circuits 130 and 140 are integrated on the first peripheral areas PA1 which are at both opposing sides of the LCD panel 110, with the gate lines GL1 to GLn therebetween. Outputs of the first and second driving circuits 130 and 140 are connected to both ends of the gate lines GL1 to GLn, respectively. The first and second gate driving circuits 130 and 140 dually drives the gates lines GL1 to GLn by sequentially supplying gate driving signals from both ends of the gate lines GL1 to GLn.

The data driving circuit 120 receives a data control signal and data from the timing controller 170, selects an analog driving voltage corresponding to the data, and then provides it to the data lines DL1 to DLm as a gray scale display voltage. The data driving circuit 120 is implemented with an integrated chip and loaded on the second peripheral area PA2 of the TFT substrate 112. The data driving circuit 120 is connected to the timing controller 170 and the power supply 180 via a flexible printed circuit board 102 connected to the second peripheral area PA2.

Although the data driving circuit 120 of the present embodiment is exemplarily loaded on the TFT substrate 112 by COG (chip on glass), it can be loaded in various ways. For instance, it may be loaded by TCP (tape carrier package) or directly integrated on the TFT substrate 112 like the first and second gate driving circuits 130 and 140.

The first and second level shifters 150 and 160 receive a gate control signal from the timing controller 170 and a driving voltage from the power supply 180, and generate a gate driving signal for driving the gate driving circuits 130 and 140. The first and second level shifters 150 and 160 then supply the generated signal to the first and second gate driving circuits 130 and 140.

The timing controller 170 receives external data and an external input control signal and generates a gate control signal and a data control signal. The timing controller 170 then supplies the generated signals to the first and second level shifters 150 and 160 and the data driving circuit 120. As used herein, data refers to red (R), green (G), and blue (B) image signals, and the input control signal includes a vertical synchronizing signal, a horizontal synchronizing signal, a main clock signal, and a data enable signal.

The power supply 180 generates an analog driving voltage, a common voltage, and a gate driving voltage using an externally supplied power voltage. The power supply 180 supplies the analog driving voltage, the common voltage, and the gate driving voltage to the data driving circuit 120, the common electrode of the LCD panel 110, and the first and second level shifters 150 and 160, respectively.

The timing controller 170, the first and second level shifters 150 and 160 and the power supply 180 are mounted on a control printed circuit board 104. The control printed circuit board 104 is connected to the second peripheral area PA2 of the TFT substrate 112 via the flexible printed circuit board 102. The first and second gate driving circuits 130 and 140 formed on the LCD panel 110 are connected to the timing controller 170 and the power supply 180 via the data driving circuit 120 or can be directly connected to the timing controller 170 and the power supply unit 170 via the flexible printed circuit board 102.

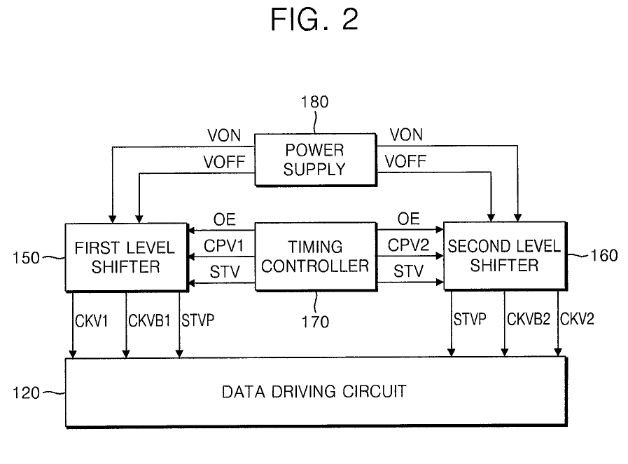

FIG. 2 is a block diagram showing input and output signals of first and second level shifters shown in FIG. 1.

Referring to FIG. 2, the first and second level shifters 150 and 160 receive a gate-on voltage VON and a gate-off voltage VOFF as gate driving voltages from the power supply 180.

The first level shifter 150 receives an output enable signal OE, a first gate clock CPV1 and a gate start signal STV from the timing controller 170. The second level shifter 160 receives the output enable signal OE, a second gate clock CPV2 and the gate start signal STV from the timing controller 170. The second gate clock CPV2 is a clock having a delayed phase of the first gate clock CPV1. The phase difference between the first and second gate clocks CPV1 and CPV2 corresponds to an interval when the gate driving signals provided to adjacent gate lines overlap each other. The gate start signal STV indicates the start of one frame.

The first level shifter 150 generates a start pulse STVP of gate-on and gate-off voltage levels, a first gate clock pulse CKV1, and a first gate clock bar pulse CKVB1 in response to a gate control signal. The second level shifter 160 generates the start pulse STVP of gate-on and gate-off voltage levels, a second gate clock pulse CKV2, and a second gate clock bar pulse CKVB2 in response to the gate control signal. The start pulse STVP enables the gate driving circuits 130 and 140 to generate a first gate driving signal of a frame. The first and second gate clock bar pulses CKVB1 and CKVB2 have phases that are the inverse of those of the first and second gate clock pulses CKV1 and CKV2 and can be used to increase the speed of driving the gate lines.

The first level shifter 150 provides the generated start pulse STVP, first gate clock pulse CKV1 and first gate clock bar pulse CKVB1 to the first gate driving circuit 130 via the data driving circuit 120. The second level shifter 160 provides the generated start pulse STVP, second gate clock pulse CKV2 and second gate clock bar pulse CKVB2 to the second gate driving circuit 140 via the data driving circuit 120.

The first and second level shifters 150 and 160 of the present embodiment, unlike those of the related art, generate the same start pulse STVP and provide the generated start pulse STVP to the first and second gate driving circuits 130 and 140. Each of the first and second gate driving circuits 130 and 140 having received the start pulse STVP generates a gate driving signal and then provides the gate driving signal to the corresponding gate line.

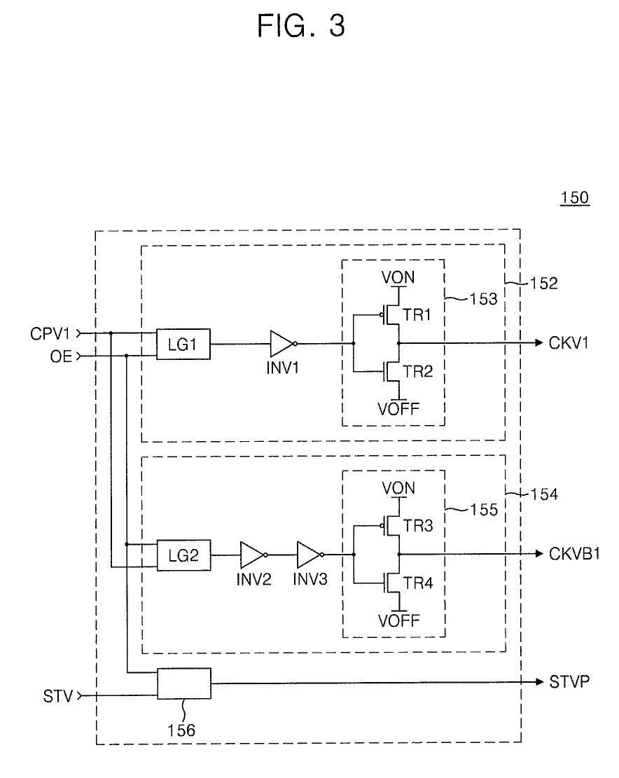

FIG. 3 is an exemplary circuit diagram of the first level shifter shown in FIG. 2.

Referring to FIG. 3, the first level shifter 150 includes first, second and third level shifting units 152, 154, and 156.

The first level shifting unit 152 performs a logical operation on the output enable signal OE and the first gate clock CPV1 and amplifies a voltage level to generate the first clock pulse CKV1. The first level shifting unit 152 then supplies the first clock pulse CKV1 to the first gate driving circuit 130. For this, the first level shifting unit 152 includes a logical operation unit LG1, a driving inverter INV1, and a full-swing inverter 153.

The logical operation unit LG1 performs an OR operation on the output enable signal OE and the first gate clock CPV1. The driving inverter INV1 inverts the phase of the output of the logical operation unit LG1 and then amplifies the inverted output to a level sufficient to drive the full-swing inverter 153. The full-swing inverter 153 generates the first gate clock pulse CKV1 of gate-on and gate-off voltage levels in response to the output of the driving inverter INV1.

The second level shifting unit 154 performs a logical operation on the output enable signal OE and the first gate clock CPV1 and amplifies a voltage level to generate the first gate clock bar pulse CKVB1. The second level shifting unit 154 then supplies the first gate clock bar pulse CKVB1 to the first gate driving circuit 130. For this, the second level shifting unit 154 includes a logical operation unit LG2, an inversion inverter INV2, a driving inverter INV3, and a full-swing inverter 155. The first gate clock bar signal CKVB is a phase-inverted clock of the first gate clock pulse CKV1.

The logical operation unit LG2 performs an OR operation on the output enable signal OE and the first gate clock CPV1. The inversion inverter INV2 inverts the phase of the output of the logical operation unit LG1. The driving inverter INV3 inverts the phase of the output of the inversion inverter INV2 and then amplifies the inverted output to a level sufficient to drive the full-swing inverter 155. The full-swing inverter 155 generates the first gate clock bar pulse CKVB1 of gate-on and gate-off voltage levels in response to the output of the driving inverter INV3.

The third level shifting unit 156 receives the output enable signal OE and the gate start signal STV and then generates the start pulse STVP of gate-on and gate-off voltage levels. The start pulse STVP has the same cycle and same pulse width as the gate start pulse STV and also has a voltage of gate-on and gate-off voltage levels.

The second level shifter 160 is substantially similar to the first level shifter 150, and therefore, further detailed description thereof will be omitted for brevity.

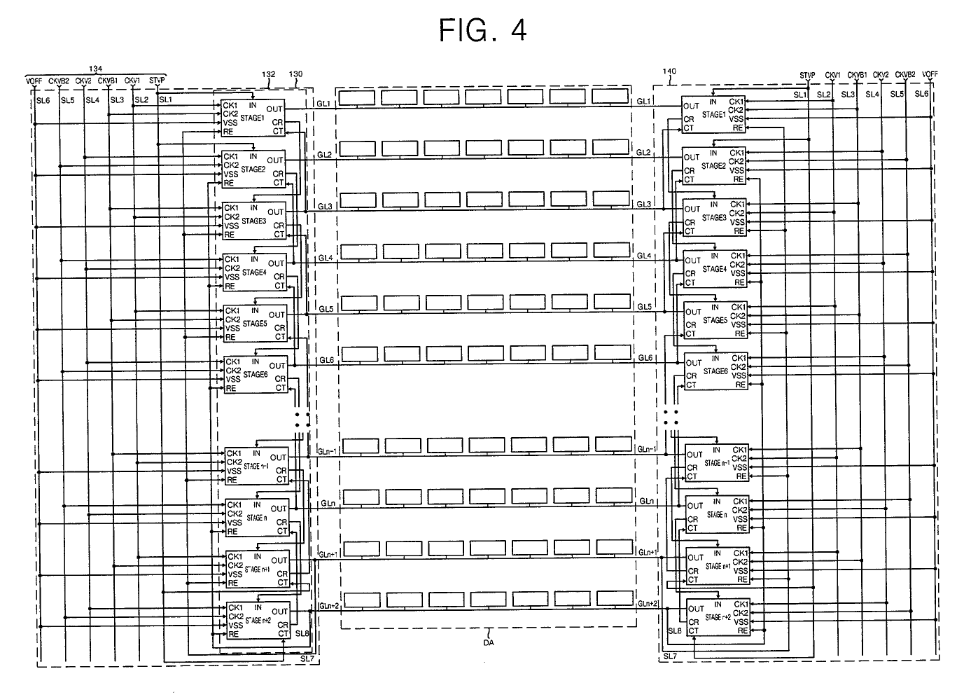

FIG. 4 is a block diagram of an exemplary embodiment of first and second gate driving circuits shown in FIG. 2.

Referring to FIG. 4, the first and second gate driving circuits 130 and 140 are arranged adjacent to the left and right sides of the display area to dually drive gate lines GL1 to GLn. The first and second gate driving circuits 130 and 140 configure a symmetric structure based on the gate lines GL1 to GLn.

The first gate driving circuit 130 includes a line unit 134 and a circuit unit 132. The line unit 134 receives various signals from the data driving circuit 120 and then delivers the received signals to the circuit unit 132. The circuit unit 132 sequentially outputs gate driving signals in response to the various signals delivered via the line unit 134.

The circuit unit 132 includes a shifter register having a plurality of stages STAGE1 to STAGEn+2 dependently connected to each other. The first to n^{th} stages STAGE1 to STAGEn are electrically connected to the first to n^{th} gate lines GL1 to GLn to sequentially output the gate driving signals. The (n+1)^{th} stage STAGEn+1 and the (n+2)^{th} stage STAGEn+2 are dummy stages, where n is an even number.

Each of the stages STAGE1 to STAGEn+2 includes a first clock terminal CK1, a second clock terminal CK2, an input terminal IN, a control terminal CT, an output terminal OUT, a reset terminal RE, a carry terminal CR, and a ground voltage terminal VSS.

The first gate clock pulse CKV1 is supplied to the first clock terminal CK1 of each of the stages STAGE1, STAGE5, . . . , and STAGEn−1 among the odd-numbered stages STAGE1 to STAGEn+2. The first gate clock bar pulse CKVB1 is supplied to the second clock terminal CK2 of each of the stages STAGE1, STAGE5, . . . , and STAGEn−1 among the odd-numbered stages STAGE1 to STAGEn+2. The first gate clock bar pulse CKVB1 is supplied to the first clock terminal CK1 of each of the stages STAGE3, STAGE7, . . . , and STAGEn+1 among the odd-numbered stages STAGE1 to STAGEn+2. The first gate clock pulse CKV1 is supplied to the second clock terminal CK2 of each of the stages STAGE3, STAGE7, . . . , and STAGEn+1 among the odd-numbered stages STAGE1 to STAGEn+2.

The input terminal IN of each of the odd-numbered stages STAGE1, STAGE3, . . . , and STAGEn+1 is connected to the carry terminal CR of a previous odd-numbered stage and is provided with a carry signal of the previous odd-numbered stage. The control terminal CT of each of the odd-numbered stages STAGE1, STAGE3, . . . , and STAGEn+1 is connected to the output terminal OUT of a next odd-numbered stage and then provided with an output signal of the next odd-numbered stage. Since the first odd stage STAGE1 is not provided with a previous stage, the start pulse STVP is supplied to the input terminal IN of the first stage STAGE1. The carry signal output from the carry terminal CR functions to drive the next odd-numbered stage.

The start pulse STVP is supplied to the control terminal CT of the dummy stage STAGEn+1 which provides the carry signal to the control terminal CT of the (n−1)^{th} stage STAGEn−1. The gate-off voltage VOFF is provided to the ground voltage terminal VSS of each of the odd stages STAGE1, STAGE3, . . . , and STAGEn+1, and an output signal of the (n+1)^{th} stage STAGEn+1 is supplied to the reset terminal RE of each of the odd stages STAGE1, STAGE3, . . . , and STAGEn+1.

The output terminal OUT of each of the odd-numbered stages STAGE1, STAGE5, . . . , and STAGEn−1 outputs the first gate clock pulse CKV1 as the gate driving signal and the carry terminal CR of each of the odd-numbered stages STAGE1, STAGE5, . . . and STAGEn−1 outputs the first gate clock pulse CKV1 as the carry signal. The output terminal OUT of each of the odd-numbered stages STAGE3, STAGE7, . . . , and STAGEn+1 outputs the first gate clock bar pulse CKVB1 as the gate driving signal and the carry terminal CR of each of the odd-numbered stages STAGE3, STAGE7, . . . and STAGEn+1 outputs the first gate clock bar pulse CKVB1 as the carry signal.

The second gate clock pulse CKV2 is supplied to the first clock terminal CK1 of each of the stages STAGE2, STAGE6, . . . , and STAGEn among the even-numbered stages STAGE2, STAGE4, . . . , and STAGEn+2, and the second gate clock bar pulse CKVB2 is supplied to the second clock terminal CK2 of each of the stages STAGE2, STAGE6, . . . , STAGEn. The second gate clock bar pulse CKVB2 is supplied to the first clock terminal CK1 of each of the stages STAGE4, STAGE8, . . . STAGEn+2 among the even-numbered stages STAGE2, STAGE4, . . . , and STAGEn+2, and the second gate clock pulse CKV2 is supplied to the second clock terminal CK2 of each of the stages STAGE4, STAGE8, . . . STAGEn+2.

The input terminal IN of each of the even-numbered stages STAGE2, STAGE4, . . . , and STAGEn+2 is connected to the carry terminal CR of a previous even-numbered stage and then provided with the carry signal of the previous even-numbered stage. The control terminal CT of each of the even-numbered stages STAGE2, STAGE4, . . . , and STAGEn+2 is connected to the output terminal OUT of a next even-numbered stage and then provided with the output signal of the next even-numbered stage. Since the first even-numbered stage STAGE2 is not provided with a previous stage, the start pulse STVP is provided to the input terminal IN of the first even-numbered stage STAGE2. The carry signal output from the carry terminal CR functions to drive the next even-numbered stage.

The start pulse STVP is supplied to the control terminal CT of the dummy stage STAGEn+2 which provides the carry signal to the control terminal CT of the n^{th} stage STAGEn. The gate-off voltage VOFF is provided to the ground voltage terminal VSS of each of the even-numbered stages STAGE2, STAGE4, . . . , and STAGEn+2. The output signal of the (n+2)^{th} stage STAGEn+2 is provided to the reset terminal RE of each of the even-numbered stages STAGE2, STAGE4, . . . , and STAGEn+2.

The output terminal OUT of each of the even-numbered stages STAGE2, STAGE6, . . . , and STAGEn outputs the second gate clock pulse CKV2 as the gate driving signal and the carry terminal CR of each of the even-numbered stages STAGE2, STAGE6, . . . , and STAGEn outputs the second gate clock pulse CKV2 as the carry signal. The output terminal OUT of each of the even-numbered stages STAGE4, STAGE8, . . . , and STAGEn+2 outputs the second gate clock bar pulse CKVB2 as the gate driving signal and the carry terminal of each of the even-numbered stages STAGE4, STAGE8, . . . , and STAGEn+2 outputs the second gate clock bar pulse CKVB2 as the carry signal.

In the structure of the first gate driving circuit 130, the odd-numbered stages STAGE1, STAGE3, . . . , and STAGEn+1 operate in synchronization with the first gate clock pulse CKV1 and the first gate clock bar pulse CKVB1, and the even-numbered stages STAGE2, STAGE4, . . . , and STAGEn operate in synchronization with the second gate clock pulse CKV2 and the second gate clock bar pulse CKVB2.

The output terminals OUT of the stages STAGE1 to STAGEn+2 of the first gate driving circuit 130 are connected to the gate lines GL1 to GLn formed in the display area and sequentially supply the gate driving signal to the gate lines GL1 to GLn to sequentially drive the gate lines GL1 to GLn.

The line unit 134 is provided in the vicinity of the circuit unit 132. The line unit 134 includes a start pulse line SL1, a first gate clock pulse line SL2, a first gate clock bar pulse line SL3, a second gate clock pulse line SL4, a second gate clock bar pulse line SL5, a ground voltage line SL6, a first reset line SL7, and a second reset line SL8, which extend in parallel with each other.

The start pulse line SL1 receives the start pulse STVP from the first level shifter 150 and then provides the received pulse to the input terminal IN of the first stage STAGE1 and the control terminal CT of the (n+1)^{th} stage STAGEn+1. The first gate clock pulse line SL2 receives the first gate clock pulse CKV1 from the first level shifter 150 and then provides the received pulse to the first clock terminal CK1 of each of the stages STAGE1, STAGE5, and STAGEn−1 among the odd-numbered stages STAGE1, STAGE3, . . . , and STAGEn+1 and to the second clock terminal CK2 of each of the odd stages STAGE3, STAGE7, . . . and STAGEn+1.

The first gate clock bar pulse line SL3 receives the first gate clock bar pulse CKVB1 from the first level shifter 150 and provides the received pulse to the first clock terminal CK1 of each of the stages STAGE1, STAGE5, . . . and STAGEn+1 among the odd-numbered stages STAGE1, STAGE3, . . . , and STAGEn+1 and to the second clock terminal CK2 of each of the stages STAGE3, STAGE7, . . . , and STAGEn+1.

The second gate clock pulse line SL4 receives the second gate clock pulse CKV2 from the second level shifter 160 and then provides the received pulse to the first clock terminal CK1 of each of the stages STAGE2, STAGE6, and STAGEn among the even-numbered stages and to the second clock terminal CK2 of each of the stages STAGE4, STAGE8, . . . and STAGEn+2.

The second gate clock bar pulse line SL5 receives the second gate clock bar pulse CKVB2 from the second level shifter 160 and provides the received pulse to the first clock terminal CK1 of each of the stages STAGE4, STAGE8, . . . , and STAGEn+2 among the even-numbered stages and to the second clock terminal CK2 of each of the stages STAGE2, STAGE6, . . . , and STAGEn.

The ground voltage line SL6 receives the gate-off voltage VOFF from the power supply 180 and then provides the received voltage to the ground voltage terminal VSS of each of the first to (n+2)^{th} stages STAGE1 to STAGEn+2.

The first reset line SL7 provides the output signal of the output terminal OUT of the (n+1)^{th} stage STAGEn+1 to the reset terminal RE of each of the odd-numbered stages STAGE1, STAGE3, . . . , and STAGEn+1. The second reset line SL8 provides the output signal of the output terminal OUT of the (n+2)^{th} stage STAGEn+2 to the reset terminal RE of each of the even-numbered stages STAGE2, STAGE4, . . . , and STAGEn+2.

The second gate driving circuit 140 is substantially similar to the first gate driving circuit 130, and therefore, further detailed description thereof is omitted for brevity.

FIG. 5 is a circuit diagram of a first stage shown in FIG. 4.

Referring to FIG. 5, the first stage STAGE1 includes a pull-up unit 132a, a pull-down unit 132b, a driving unit 132c, a holding unit 132d, a switching unit 132e, and a carry unit 132f.

The pull-up unit 132a pulls up the first gate clock pulse CKV1 provided via the first clock terminal CK1 and then outputs a gate driving signal GO1 via the output terminal OUT. The pull-up unit 132a includes a first transistor NT1 having a gate connected to a first node N1, a drain connected to the first clock terminal CK1, and a source connected to the output terminal OUT.

The pull-down unit 132b pulls down the gate driving signal GO1 to the gate-off voltage VOFF provided via the ground voltage terminal VSS in response to a gate driving signal GO3 from the third stage. The pull-down unit 132b includes a second transistor NT2 having a gate connected to the control terminal CT, a drain connected to the output terminal OUT, and a source connected to the ground voltage terminal VSS.

The driving unit 132c turns on the pull-up unit 132a in response to the start pulse STVP provided via the input terminal IN or turns off the pull-up unit 132a in response to the gate driving signal GO3 of the third stage. For this, the driving unit 132c includes a buffer unit, a charge unit, and a discharge unit.

The buffer unit includes a third transistor NT3 having a gate and drain connected commonly to the input terminal IN and a source connected to the first node N1. The charge unit includes a first capacitor C1 having a first electrode connected to the first node N1 and a second electrode connected to a second node N2. The discharge unit includes a fourth transistor NT4 having a gate connected to the control terminal CT, a drain connected to the first node N1, and a source connected to the ground voltage terminal VSS.

When the start pulse STVP is input to the input terminal IN, the third transistor NT3 is turned on and the first capacitor C1 is charged with the start pulse STVP. When the first capacitor C1 is charged over a threshold voltage of the first transistor NT1, the first transistor NT1 is turned on and then outputs the first gate clock pulse CKV1, which is provided to the first clock terminal CK1, to the output terminal OUT.

The potential of the first node N1 becomes boot-strapped as much as the potential variation of the second node N2 by coupling of the first capacitor C1 according to an abrupt potential change of the second node N2. So, the first transistor NT1 is facilitated to output the first gate clock pulse CKV1 applied to the drain to the output terminal OUT. The first gate clock pulse CKV1 output to the output terminal OUT becomes the gate driving signal GO1 provided to a gate line. The start pulse STVP is used as a preliminary signal for charging the first transistor NT1 to generate the first gate driving signal.

Subsequently, when the fourth transistor NT4 is turned on in response to the gate driving signal GO3 that is the output signal of the third stage input via the control terminal CT, charges in the first capacitor C1 are discharged to a gate-off voltage level provided via the ground voltage terminal VSS.

The holding unit 132d includes fifth and sixth transistors NT5 and NT6 for holding the gate driving signal GO1 at the gate-off voltage level. The fifth transistor NT5 has a gate connected to a third node N3, a drain connected to the second node N2, and a source connected to the ground voltage terminal VSS. The sixth transistor NT6 has a gate connected to the second clock terminal CK2, a drain connected to the second node N2, and a source connected to the ground voltage terminal VSS.

The switching unit 132e includes seventh to tenth transistors NT7 to NT10 and second and third capacitors C2 and C3 to control the holding unit 132d. The seventh transistor NT7 has a gate and drain connected to the first clock terminal CK1 and a source connected commonly to a drain of the ninth transistor NT9 and a gate of the eighth transistor NT8. The eighth transistor NT8 has a drain connected to the first clock terminal CK1, a gate connected to the drain via the second capacitor C2, and a source connected to the third node N3. The gate and source of the eighth transistor NT8 are connected to each other via the third capacitor C3. The ninth transistor NT9 has a drain connected to the source of the seventh transistor NT7, a gate connected to the second node N2, and a source connected to the ground voltage terminal VSS. The tenth transistor NT10 has a drain connected to the third node N3, a gate connected to the second node N2, and a source connected to the ground voltage terminal VSS.

When the gate clock pulse CKV1 of a high state is output to the output terminal OUT as the gate driving signal GO1, the potential of the second node N2 is raised to a high state. When the potential of the second node N2 is raised to the high state, the ninth and tenth transistors NT9 and NT10 are turned on. In this case, although the seventh and eighth transistors NT7 and NT8 are turned on by the first gate clock pulse CKV1 provided to the first clock terminal CK1, signals output from the seventh and eighth transistors NT7 and NT8 are discharged to the ground voltage via the ninth and tenth transistors NT9 and NT10. Since the potential of the third node N3 is maintained at a low state while the gate driving signal GO1 of a high state is output, the fifth transistor NT5 can maintain the turned-off state.

Subsequently, the gate driving signal GO1 is discharged via the ground voltage terminal VSS in response to the driving signal GO3, which is input via the control terminal CT, of the third stage. The potential of the second node N2 gradually falls to a low state. The ninth and tenth transistors NT9 and NT10 are turned off and the potential of the third node N3 is raised to a high state by signals output from the seventh and eighth transistors NT7 and NT8. As the potential of the third node N3 is raised, the fifth transistor NT5 is turned on, and the potential of the second node N2 is discharged to the gate-off voltage VOFF via the fifth transistor NT5.

When the sixth transistor NT6 is turned on by the first gate clock bar pulse CKVB1 provided via the second clock terminal CK2, the potential of the second node N2 is discharged via the ground voltage terminal VSS more surely.

Consequently, the fifth and sixth transistors NT5 and NT6 of the holding unit 132d hold the potential of the second node N2 at the gate-off voltage VOFF. The switching unit 132e decides a timing point at which the fifth transistor NT5 is turned on.

The carry unit 132f includes an eleventh transistor NT11 having a drain connected to the first clock terminal CK1, a gate connected to the first node N1, and a source connected to the carry terminal CR and includes a fourth capacitor C4 connected between the gate and source of the eleventh transistor NT11. The eleventh transistor NT11 is turned on as the potential of the first node N1 is raised. The eleventh transistor NT11 then outputs the first gate clock pulse CKV1 input to its drain as a carry signal CASig1. Similarly, the fourth capacitor C4 turns on the eleventh transistor NT11 by charging the start pulse STVP. The carry signal CASig1 is provided to an input terminal of the second stage to be used as the start pulse for driving the second stage.

The first stage STAGE1 further includes a ripple preventing unit 132g and a reset unit 132h. The ripple preventing unit 132g prevents the gate driving signal GO1 maintaining the gate-off voltage VOFF from being rippled by noises input via the input terminal IN. The ripple preventing unit 132g includes twelfth and thirteenth transistors NT12 and NT13. The twelfth transistor NT12 has a drain connected to the input terminal IN, a gate connected to the second clock terminal CK2, and a source connected to the first node N1. The thirteenth transistor NT13 has a drain connected to the first node N1, a gate connected to the first clock terminal CK1, and a source connected to the second node N2.

The reset unit 132h includes a fourteenth transistor NT14 having a drain connected to the first node N1, a gate connected to the reset terminal RE, and a source connected to the ground voltage terminal VSS. The fourteenth transistor NT14 discharges the first node N1 to the gate-off voltage VOFF in response to an output signal GOn+1, which is input via the reset terminal RE, of the (n+1)^{th} stage STAGEn+1. Since the output of the (n+1)^{th} stage STAGEn+1 means an end of one frame, the reset unit 132h simultaneously discharges the first nodes N1 of the odd-numbered stages STAGE1, STAGE3, . . . STAGEn−1 when one frame ends.

The reset unit 132h resets the first nodes N1 of the odd-numbered stages STAGE1, STAGE3, . . . , and STAGEn+1 to the gate-off voltage VOFF by turning on the fourteenth transistor NT14 of each of the odd-numbered stages STAGE1, STAGE3, . . . , and STAGEn+1 by the output signal of the (n+1)th stage STAGEn+1 after the gate driving signals are sequentially output from the odd-numbered stages STAGE1, STAGE3, . . . , and STAGEn+1. Hence, the odd-numbered stages STAGE1, STAGE3, . . . , and STAGEn+1 of the circuit unit 132 can restart their operations in a reset state.

The second to (n+2)^{th} stages shown in FIG. 4 are substantially similar to first stage, and therefore, further description thereof is omitted for brevity.

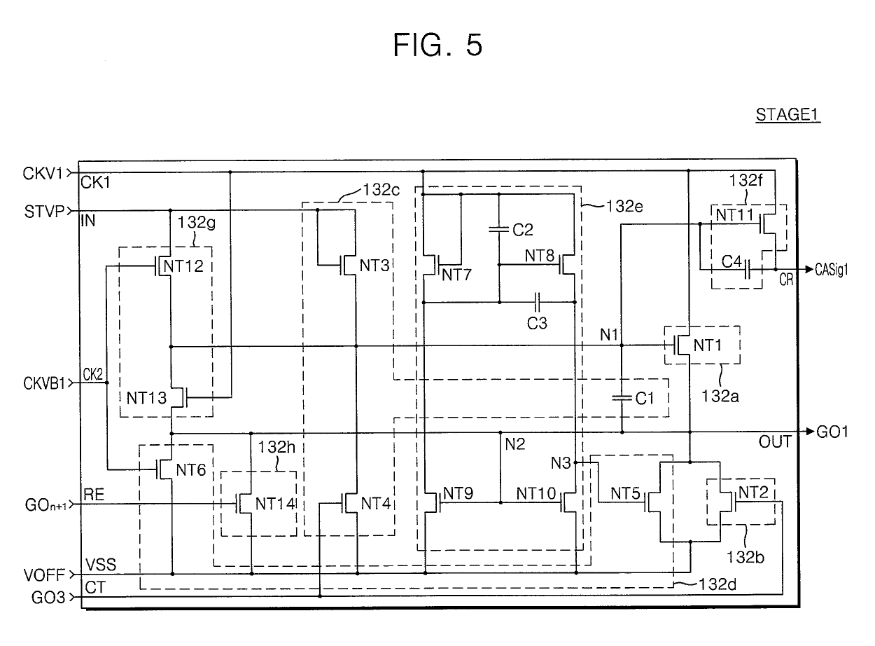

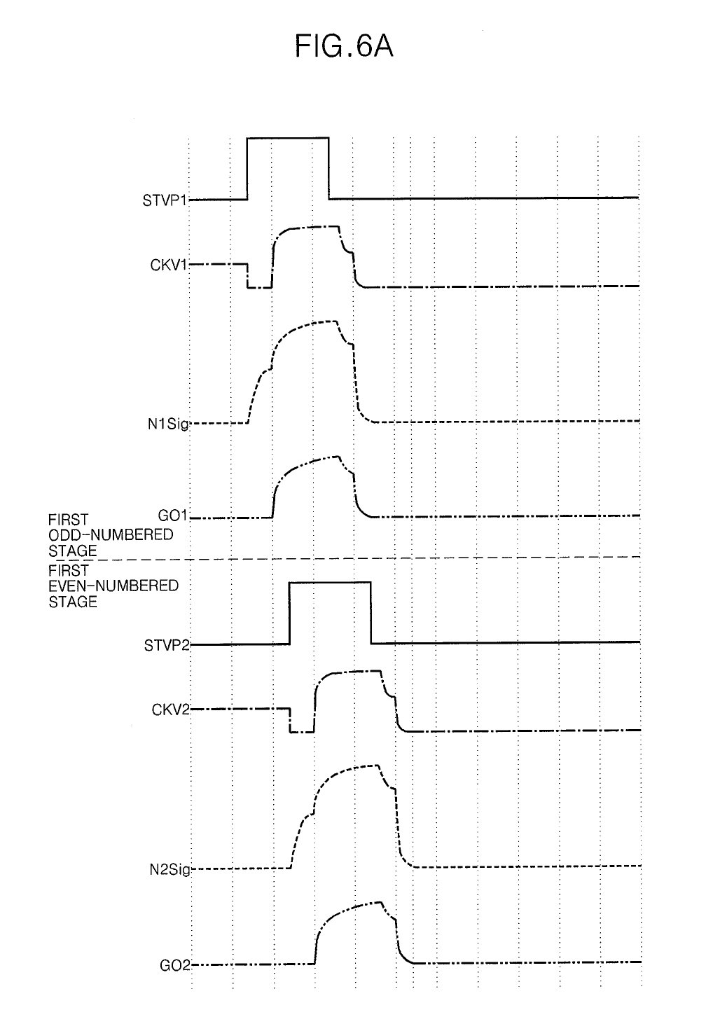

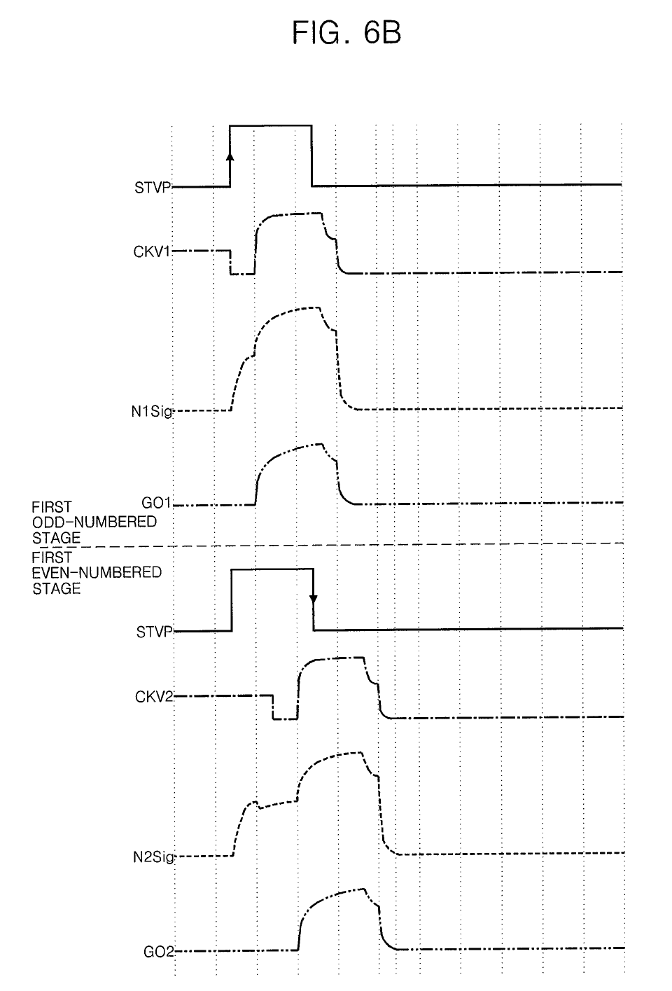

FIG. 6A and FIG. 6B are graphs for comparing operations of gate driving circuits by start pulses in a related art LCD and in an LCD according to one embodiment of the present invention.

The operation of a gate driving circuit in correspondence to a start pulse of the related art LCD is explained with reference to FIG. 6A.

Referring to FIG. 6A, the gate driving circuit of the related art LCD is driven by a first start pulse STVP1 for driving a first odd-numbered stage and a second start pulse STVP2 for driving a first even-numbered stage.

The second start pulse STVP2 is provided to an input terminal of the first even-numbered stage after the first start pulse STVP1 is provided to an input terminal of the first odd-numbered stage. In particular, assuming that the time during which a gate-on voltage VON supplied to a single gate line is maintained at a high level state is ‘tON’, the second start pulse STVP2 is provided after duration of ‘tON/2’ after the first start pulse STVP1 is provided. This is to compensate for the charging ratio shortage due to the gate line delay according to the manner of overlapping gate driving signals provided to adjacent gate lines.

The first and second start pulses STVP1 and STVP2 are used only as preliminary signals N1sig and N2Sig for turning on the first transistors that are the pull-up units 132a of the first odd-numbered stage and the first even-numbered stage but do not affect timings of gate driving signals GO1 and GO2 that are output from the first odd-numbered stage and the first even-numbered stages, respectively. This is because the gate driving signals GO1 and GO2 are output from the first odd-numbered stage and the first even-numbered stage in synchronization with the first and second gate clock pulses CKV1 and CKV2, respectively.

The operation of a gate driving circuit in correspondence to a start pulse of an LCD according to one embodiment of the present invention is explained with reference to FIG. 6B.

Referring to FIG. 6B, a gate driving circuit of an LCD according to one embodiment of the present invention drives the first odd-numbered stage and the even-numbered stage using a single start pulse STVP.

The start pulse STVP may be the same pulse as the related art first start pulse STVP1. The rising timing point of the start pulse STVP is equal to that of the related art first start pulse STVP1, and the falling timing point thereof is prior to inputting the second gate clock pulse CKV2 to an input terminal of the first even-numbered stage.

The start pulse STVP is simultaneously provided to the input terminals of the first odd-numbered stage and the first even-numbered stage. The first odd-numbered stage generates a preliminary signal N1 sig for turning on the first transistor of the first odd-numbered stage in advance by charging the start pulse STVP to the first capacitor of the first odd-numbered stage and outputs the gate driving signal GO1 in synchronization with the first gate clock pulse CKV1. The first even-numbered stage generates a preliminary signal N2sig for turning on the first transistor of the first even-numbered stage in advance by charging the start pulse STVP to the first capacitor of the first even-numbered stage and outputs the gate driving signal GO2 in synchronization with the second gate clock pulse CKV2.

The first capacitor of the first even-numbered stage generates the preliminary signal N2sig for turning on the first transistor by starting charging at a timing point of charging the first capacitor of the first odd-numbered stage with the start pulse STVP. Namely, the first capacitor of the first even-numbered stage keeps charging until the second gate clock pulse CKV2 of a high state is input in addition to the time during which the first capacitor of the first odd-numbered stage keeps charging to generate the preliminary signal. When the second gate clock pulse CKV2 of a high state is input, the first even-numbered stage outputs it as the gate driving signal GO2.

Hence, the LCD according to one embodiment of the present invention becomes operative in a manner that the first odd-numbered stage and the first even-numbered stage share a single start pulse STVP. Thus, the space for integrating lines for providing the first and second start pulses of the related art can be reduced to a half.

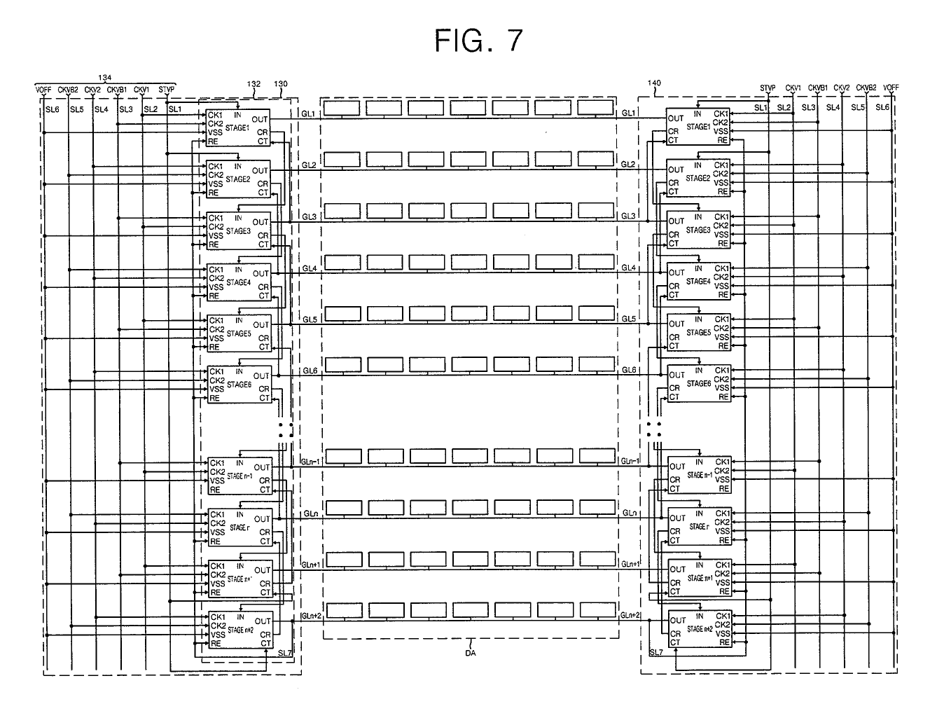

FIG. 7 is a block diagram of another exemplary embodiment of the first and second gate driving circuits shown in FIG. 2.

Referring to FIG. 7, a first gate driving circuit 130 includes a line unit 134 for receiving various signals from the data driving circuit and a circuit unit 132 sequentially outputting gate driving signals in response to the various signals delivered by the line unit 134.

The circuit unit 132 includes a plurality of stages STAGE1 to STAGEn+2 dependently connected to one another. An output signal of the (n+2)^{th} stage STAGEn+2 is provided to a reset terminal RE of each of a plurality of stages STAGE1 to STAGEn+2.

The line unit 134 includes a start pulse line SL1, a first gate clock pulse line SL2, a first gate clock bar pulse line SL3, a second gate clock pulse line SL4, a second gate clock bar pulse line SL5, a ground voltage line SL6, and a reset line SL7. The reset line SL7 provides an output signal of an output terminal OUT of the (n+2)^{th} stage STAGEn+2 to the reset terminals RE of the stages STAGE1 to STAGEn+2.

In other words, the first gate driving circuit 130 according to another embodiment of the present invention has a structure in which the odd-numbered stages STAGE1, STAGE3, . . . , and STAGEn+1 and the even-numbered stages STAGE2, STAGE4, . . . , and STAGEn+2 share a single reset signal. Since the second driving circuit 140 is substantially similar to the first gate driving circuit 130, further detailed description thereof is omitted for brevity.

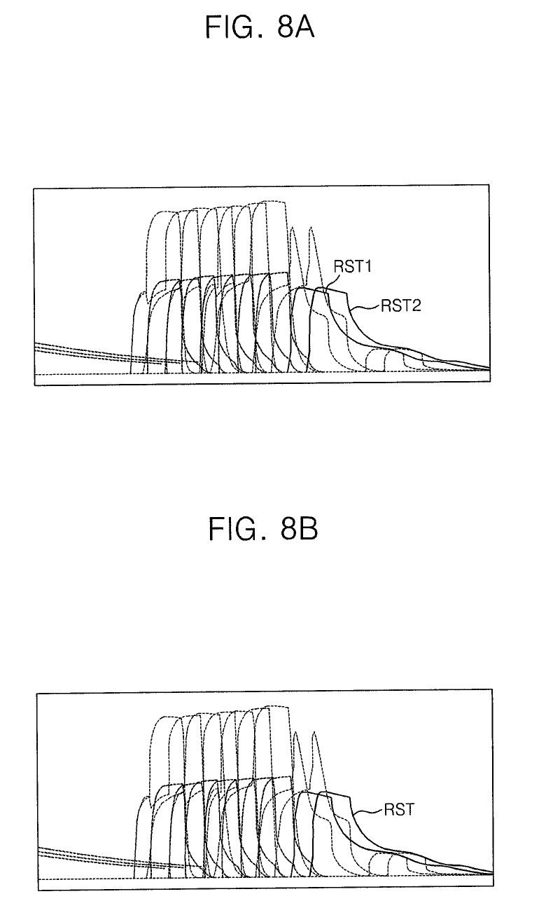

FIG. 8A and FIG. 8B are graphs for comparing operations of gate driving circuits in a related art LCD and in an LCD according to another embodiment of the present invention.

Referring to FIG. 8A, in a gate driving circuit of a related art LCD, odd-numbered stages STAGE1, STAGE3, . . . , and STAGEn+1 are reset by a first reset signal RST1 that is an output signal of the (n+1)^{th} stage STAGEn+1 and even-numbered stages STAGE2, STAGE4, . . . , and STAGEn+2 are reset by a second reset signal RST2 that is an output signal of the (n+2)^{th} stage STAGEn+2.

Referring to FIG. 8B, in a gate driving circuit of an LCD according to another embodiment of the present invention, the odd-numbered stages STAGE1, STAGE3, . . . , and STAGEn+1 and the even-numbered stages STAGE2, STAGE4, . . . , and STAGEn+2 are simultaneously reset by a single reset signal RST that is an output signal of the (n+2)^{th} stage STAGEn+2.

The reset signal RST indicates an end of one frame and discharges the first nodes N1 by turning on the fourteenth transistors NT14 of the stages (see FIG. 5). So, although the odd-numbered stages STAGE1, STAGE3, . . . , and STAGEn+1 are reset by providing the output signal of the (n+2)^{th} stage as the reset signal RST to the reset terminals RE of the odd-numbered stages STAGE1, STAGE3, . . . , and STAGEn+1, a problem of timing is not generated.

Hence, the LCD according to another embodiment of the present invention becomes operative in a manner that the odd-numbered stages STAGE1, STAGE3, . . . , and STAGEn+1 and the even-numbered stages STAGE2, STAGE4, . . . , and STAGEn+2 share a single reset signal RST. Thus, the space for integrating lines for providing the first and second reset signals of the related art can be reduced into a half.

The pull-up unit 132a of the (n+2)^{th} stage STAGEn+2 of each of the first and second driving circuits 130 and 140 shown in FIG. 7 includes a transistor having a size larger than the first transistor NT1 of each of the first to (n+1)^{th} stages STAGE1 to STAGEn+1 as the pull-up unit 132a. This is because the pull-up unit 132a of the (n+2)^{th} stage STAGEn+2 performs a function of stabilizing the gate-off voltage VOFF supplied to gate lines by simultaneously driving the transistors NT14 configuring the reset units 132h of the first to (n+2)^{th} stages STAGE1 to STAGEn+2.

The first transistor NT1 configuring the pull-up unit 132a of the (n+2)^{th} stage STAGEn+2 is desirable to have a size about 2 to 2.5 times larger than that of the transistor configuring the pull-up unit 132a of each of the first to (n+1)^{th} stages STAGE1 to STAGEn+1. The first transistor NT1 configuring the pull-up unit 132a of the (n+2)^{th} stage STAGEn+2 is configured to have a size about 2.3 times larger than that of the transistor configuring the pull-up unit 132a of each of the first to (n+1)^{th} stages STAGE1 to STAGEn+1.

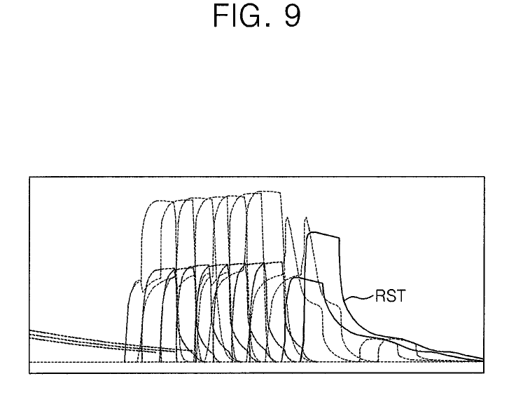

FIG. 9 is a graph showing an output waveform of an (n+2)^{th} stage of each of the first and second gate driving circuits shown in FIG. 7.

Referring to FIG. 9, the odd-numbered stages STAGE1, STAGE3, and STAGEn+1 and the even-numbered stages STAGE2, STAGE4, . . . , and STAGEn+2 are simultaneously reset by a single reset signal RST that is an output signal of the (n+2)^{th} stage STAGEn+2. Since the reset signal RST is generated by the pull-up unit including a transistor having a size about 2.5 times lager than that of the transistor configuring the pull-up unit of each of the first to (n+1)^{th} stages, it can be observed that the reset signal RST is the signal having driving capability greater than that of the gate driving signal generated by the pull-up unit of each of the first to (n+1)^{th} stages STAGE1 to STAGEn+1.

As described above, the present invention reduces signal lines connected to a gate driving circuit by sharing a start pulse of a dual gate driving circuit and an output signal of a dummy stage, thereby reducing the integrated space of the signal line. Since the existing LCD panel and existing equipment for an LCD panel process can be used due to the reduced integrated space, the fabricating costs of the LCD panel can be reduced.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A gate driving circuit comprising:
a circuit unit having a plurality of stages dependently connected to each other to output a gate clock pulse or a gate clock bar pulse as a gate driving signal for each of the gate lines in response to a single start pulse; and
a line unit having a start pulse line receiving the start pulse to provide the received start pulse to an input terminal of each of a first odd-numbered stage and a first even-numbered stage of the stages,
wherein output terminals of the stages are connected to the gate lines, respectively.

2. The gate driving circuit of claim 1, wherein odd-numbered stages of the stages output the gate clock pulse as the gate driving signal and wherein even-numbered stages of the stages output the gate clock bar pulse as the gate driving signal.

3. The gate driving circuit of claim 2, wherein each input terminal of the stages is connected to a carry terminal of a previous stage and wherein each control terminal of the stages is connected to an output terminal of a next stage.

4. The gate driving circuit of claim 3, wherein the odd-numbered stages include a first dummy stage having the carry terminal connected to the control terminal of the last odd-numbered stage and wherein the even-numbered stages include a second dummy stage having the carry terminal connected to the control terminal of the last even-numbered stage.

5. The gate driving circuit of claim 4, wherein the line unit comprises:
a first reset line connecting an output terminal of the first dummy stage to a reset terminal of each of the odd-numbered stages; and
a second reset line connecting an output terminal of the second dummy stage to a reset terminal of each of the even-numbered stages.

6. The gate driving circuit of claim 4, wherein the line unit includes a reset line connecting an output terminal of the second dummy stage to reset terminals of the stages and wherein the second dummy stage provides a reset signal to the reset line via the output terminal.

7. The gate driving circuit of claim 6, wherein the second dummy stage includes a pull-up transistor for providing the reset signal and wherein the pull-up transistor has a size larger than that of a pull-up transistor of each of the other stages.

8. A liquid crystal display comprising:
a timing controller generating an output enable signal, a gate clock, and a single start signal in response to an external input signal;
a level shifter generating a gate clock pulse and a gate clock bar pulse in response to the output enable signal and the gate clock and generating a single start pulse in response to the start signal and the gate clock; and
first and second gate driving circuits outputting the gate clock pulse or the gate clock bar pulse as a gate driving signal to be provided to a plurality of gate lines in response to the single start pulse.

9. The liquid crystal display of claim 8, wherein the first and second gate driving circuits are integrated on a liquid crystal display panel having the gate lines formed thereon and are formed at both ends of the gate lines to dually drive the gate lines.

10. The liquid crystal display of claim 9, wherein each of the first and second gate driving circuits includes a plurality of stages dependently connected to each other and wherein output terminals of the stages are connected to the gate lines, respectively.

11. The liquid crystal display of claim 10, wherein each of odd-numbered stages of the stages outputs the gate clock pulse as the gate driving signal and wherein each of even-numbered stages of the stages outputs the gate clock bar pulse as the gate driving signal.

12. The liquid crystal display of claim 11, wherein an input terminal of each of the stages is connected to a carry terminal of a previous stage and wherein a control terminal of each of the stages is connected to an output terminal of a next stage.

13. The liquid crystal display of claim 12, wherein the odd-numbered stages include a first dummy stage having a carry terminal connected to a control terminal of the last odd-numbered stage and wherein the even-numbered stages include a second dummy stage having a carry terminal connected to a control terminal of the last even-numbered stage.

14. The liquid crystal display of claim 13, wherein a reset terminal of each of the odd-numbered stages is connected to an output terminal of the first dummy stage and wherein a reset terminal of each of the even-numbered stages is connected to an output terminal of the second dummy stage.

15. The liquid crystal display of claim 13, wherein a reset terminal of each of the stages is connected to an output terminal of the second dummy stage.

16. The liquid crystal display of claim 15, wherein the second dummy stage includes a pull-up transistor connected to the reset terminal and wherein the pull-up transistor has a size larger than that of a pull-up transistor of each of the other stages.

17. The liquid crystal display of claim 9, further comprising a power supply for supplying a gate-on voltage and a gate-off voltage to the level shifter and wherein the level shifter outputs the gate clock pulse, the gate clock bar pulse and the start pulse as a gate-on voltage level and a gate-off voltage level.

18. The liquid crystal display of claim 17, wherein the level shifter comprises:
a first level shifting unit outputting the gate clock pulse by performing a logical operation on the output enable signal and the gate clock and amplifying a voltage level; and
a second level shifting unit outputting the gate clock bar pulse by performing a logical operation on the output enable signal and the gate clock, inverting a phase, and amplifying a voltage level.

19. The liquid crystal display of claim 18, wherein the first level shifting unit comprises:
a logical operation unit performing an OR operation on the output enable signal and the gate clock;
a driving inverter inverting the phase of the output of the logical operation unit and amplifying it; and
a full-swing inverter generating the gate clock pulse of the gate-on voltage level and the gate-off voltage level in response to an output of the driving inverter.

20. The liquid crystal display of claim 18, wherein the second level shifting unit comprises:
a logical operation unit for performing an OR operation on the output enable signal and the gate clock;
an inversion inverter inverting the phase of the output of the logical operation unit;
a driving inverter inverting the phase of the output of the inversion inverter and amplifying it; and
a full-swing inverter generating the gate clock bar pulse of the gate-on voltage level and the gate-off voltage level in response to an output of the driving inverter.
